(19) United States
(12) Patent Application Publication
(10) Pub. No.: US 2016/0334007 A1
(43) Pub. Date: Nov. 17, 2016

(54) PLANETARY GEAR PIN WITH FLANGE THAT CAN BE BOLTED TO THE PLANETARY CARRIER

(71) Applicant: ZF FRIEDRICHSHAFEN AG, Friedrichshafen (DE)

(72) Inventor: Ulf LANG, Salem (DE)

(21) Appl. No.: 15/110,775

(22) PCT Filed: Dec. 15, 2014
(86) PCT No.: PCT/EP2014/077697

§ 371 Date: Jul. 11, 2016

(30) Foreign Application Priority Data
Jan. 14, 2014 (DE) 10 2014 200 463.2

(51) Int. Cl. F16H 57/08

(52) U.S. Cl. CPC F16H 57/082

(57) ABSTRACT

A planetary bolt (103) having a flange (109) and at least one through-bore with two open ends. The flange (109) contains the open ends and the flange (109) can be bolted to a planetary carrier (101).

This application is a National Stage completion of PCT/EP2014/077697 filed Dec. 15, 2014, which claims priority from German patent application serial no. 10 2014 200 463.2 filed Jan. 14, 2014.

### FIELD OF THE INVENTION

The invention concerns a planetary bolt and a planetary carrier, onto which the planetary bolt can be bolted.

### BACKGROUND OF THE INVENTION

Transmissions in wind turbines are exposed to high loads, which lead to distortions of the planetary carrier. To make the planetary carrier more rigid, the planetary bolts are fixed into the planetary carrier by means of a press fit. The press fit makes it possible to absorb bending moments through the planetary bolts. Moreover, by virtue of the press fit the planetary bolt is fixed in the axial direction.

Particularly when conical roller bearings are used, the planetary bolts are loaded by forces in the axial direction. Consequently, corresponding forces in the radial direction act upon the press-fit connection between the planetary carrier and the planetary bolt.

An obvious possibility for increasing the load-bearing capacity of press fits subjected to such forces and thereby improving the load-bearing capacity of the planetary bolts, would be to increase the dimensional difference between the planetary bolts and the bolt seats in the planetary carrier. This would increase the normal forces acting on the planetary bolts in the press-fit connections. However, during assembly the planetary carriers would have to be heated to a higher temperature before the planetary bolts could be inserted into the planetary carrier. This would involve a greater risk of burn injuries for the assembly workers. Furthermore, the stresses produced in the planetary carrier as a result of the press-fit connection would be greater. The higher load-bearing capacity of the planetary bolts would be offset by reduced load-bearing capacity of the planetary carrier.

A solution for these problems is to combine the fixing of the planetary bolts by press-fitting, with bolting them in by means of screw-bolts. From the prior art corresponding solutions are known, in which the planetary bolts are fixed by screw-bolts into the planetary carrier. In this case the screw-bolts extend in the axial direction through the planetary bolts. For that purpose the planetary bolts have axially directed through-bores that pass completely through the planetary bolt, i.e. from one end face of the planetary bolt to an opposite end face.

In this arrangement the screw joint is formed in the lateral part of the planetary carrier on the rotor side. This area, however, is subjected to high loads. Besides a load due to a rotor torque, a bending moment acts there because of the weight of the rotor. The screw joint imposes an additional load on the lateral part on the rotor side. Furthermore, the threaded bore required results in structural weakening.

The screw-bolts used have to be correspondingly long. Consequently, the axial rigidity of the screw-bolts is low. Thus, when acted upon by a load in the axial direction the screw-bolts are comparatively compliant. When a planetary bolt is severely loaded in the axial direction, this can result in a displacement of the planetary bolt relative to the planetary carrier. This brings the risk that the planetary bearing will lose its prestress or that the bearing play will change. The result is damage to the bearing.

Furthermore, it is possible that the planetary gearwheels will be displaced in the axial direction relative to the ring gear. This can result in damage to the ring gear and the planetary gearwheels.

### SUMMARY OF THE INVENTION

The purpose of the present invention is to fix a planetary bolt into a planetary carrier while circumventing the disadvantages inherent in the solutions known from the prior art. In particular, the load-bearing capacity of the planetary bolt in the axial direction should be improved.

This objective is achieved by a planetary bolt as described below and a planetary carrier for receiving the planetary bolt, such that a flange of the planetary bolt can be bolted onto the planetary carrier.

According to the invention, the planetary carrier is provided with at least one through-bore which has two open ends. The through-bore passes completely within the flange. Correspondingly, the flange comprises the two open ends.

In general a through-bore is understood to mean a bore that passes completely through the workpiece. Thus, in the area of the flange the through-bore passes completely through the planetary bolt.

The through-bore passes through the surface of the workpiece, the planetary bolt or the flange, at two points. These points are referred to as the open ends. The open ends are each bounded by a surrounding edge, which extends along the surface of the workpiece, the planetary bolt or the flange and along which the surface merges into the through-bore. Thus, the edge separates the surface from the through-bore. In particular, the edge is a boundary line between the surface and the through-bore.

The flange is an area of the planetary bolt which, relative to the remainder of the planetary bolt, projects outward in the radial direction, i.e. perpendicularly to the axis of symmetry of at least part of the planetary bolt, the rotational axis of the planetary bearing and the rotational axis of a planetary gearwheel fitted onto the planetary bolt. In particular the flange can be an area of the planetary bolt that has at least one shoulder. The shoulder is a surface that extends at least partially radially, preferably radially. A surface extending at least partially radially is a surface that extends in a direction not parallel to the symmetry axis of at least part of the planetary bolt, the rotational axis of the planetary bearing and the rotational axis of a planetary gearwheel fitted onto the planetary bearing. The surface extends radially when it is perpendicular to the axes.

The through-bore according to the invention passes through the shoulder, i.e. the shoulder contains one of the open ends. Thus, one of the open ends lies in the surface forming the shoulder.

Preferably, the surface has two shoulders. In that case a first shoulder—as known from the prior art—serves for fixing the planetary bearing in the axial direction. The first shoulder is therefore in contact with an inner race of the planetary bearing, either directly or by way of an intermediate component inserted between the shoulder and the inner race.

The second shoulder can be designed to come in contact with a corresponding surface of the planetary carrier that extends along the second shoulder, either directly or by way of an intermediate component inserted between the second shoulder and the surface of the planetary carrier. By virtue of the contact between the second shoulder and the surface of the planetary carrier, the planetary bolt is fixed in the axial direction. Thus, for the second shoulder the surface of the planetary carrier forms an abutment. In particular, for this purpose the surface of the planetary carrier extends along the second shoulder when the planetary bolt has been introduced into the planetary carrier. This also means that the surface of the planetary carrier extends radially or partially radially.

Alternatively, there may be a gap between the second shoulder and the surface of the planetary carrier.

Preferably—as known from the prior art—the planetary bolt comprises at least one cylindrical section. This section serves on the one hand to fix the planetary bolt in the planetary carrier, in particular by means of a press connection between a bolt seat in the planetary carrier and the cylindrical section. In addition the cylindrical section serves to receive the planetary bearing and fix it, especially in the radial direction.

In this context cylindrical means that the section has the shape of a straight, circular cylinder.

The flange is not part of the cylindrical section. Correspondingly, the flange is an area which, relative to the cylindrical section, projects outward in the radial direction. In the radial direction the flange extends outside the cylindrical section.

The through-bore serves to enable the planetary bolt to be bolted onto the planetary carrier. For that purpose it is advantageous for the through-bore to extend axially, i.e. parallel to the symmetry axis of at least part of the planetary bolt, the rotational axis of the planetary bearing and the rotational axis of the planetary gearwheel fitted onto the planetary bearing.

When the planetary bolt has been inserted in the planetary carrier, so that two bolt seats of the planetary carrier are holding the planetary bolt, a screw-bolt can be guided through the through-bore. The planetary carrier has an internal thread into which the screw-bolt can be screwed. For this, the internal thread and the through-bore are arranged coaxially with one another. In other words the internal thread and the through-bore are aligned.

Furthermore, the planetary carrier forms an abutment for a head of the screw-bolt. This enables the screw-bolt to be tightened between the planetary bolt and the planetary carrier or the flange. In this way the first shoulder of the planetary bolt is braced against the inner race of one of the planetary bearings and, depending on the design, the second shoulder is braced against the surface of the planetary carrier extending along the second shoulder, in such manner that a defined axial play or a prestress of the planetary bearing is produced. In particular, this makes it possible to determine the axial play or the prestress before the press-fit connection between the bolt seats of the planetary carrier and the planetary bolt has been formed.

Otherwise than in the solutions known from the prior art, the through-bore does not pass all the way through the entire planetary bolt, but only through the flange. This enables the use of shorter screw-bolts, which correspondingly have greater axial rigidity. Accordingly, axial displacements of the planetary bolt relative to the planetary carrier can be reliably prevented, even under high axial loads of the planetary bolt. The planetary bolt is screwed onto the lateral part on the generator side and there is therefore no structural weakening of the lateral part of the planetary carrier on the rotor side. A force acting on the rotor-side lateral part owing to the screw connection is also avoided.

In a preferred further development, the flange is rotationally asymmetrical, i.e. not designed with rotational symmetry. Correspondingly, an area of the planetary carrier that receives the flange is also rotationally asymmetrical. This prevents the planetary bolt from twisting relative to the planetary carrier. Thus, a rotationally asymmetrically designed flange results in further improvement of the load-bearing capacity.

Furthermore, it is preferable for the through-bore to be arranged eccentrically. This means that the axis of symmetry of the through-bore is different from the symmetry axis of at least part of the planetary bolt, the rotational axis of the planetary bearing and the rotational axis of the planetary gearwheel fitted onto the planetary bolt. Thus, the symmetry axis of the through-bore extends at distance, which is not vanishingly small or zero, away from the symmetry axis of at least part of the planetary bolt, the rotational axis of the planetary bearing and the rotational axis of the planetary gearwheel fitted onto the planetary bolt. The eccentric arrangement of the through-bore also prevents the planetary bolt from twisting relative to the planetary carrier.

In another preferred further development, the planetary bolt is designed such that the flange has at least a first surface, a second surface and a third surface. The third surface connects the first and second surfaces. Thus, the third surface is between the first and second surfaces.

The third surface has exactly two boundary lines. These in each case extend all round, forming closed figures. One of the boundary lines is at the same time a boundary line of the first surface. The other boundary line is at the same time the boundary line of the second surface.

The third surface is the second shoulder. Correspondingly, one of the open ends of the through-bore is located in the third surface.

At least the first surface is designed to form an interlocking connection in a press fit with one of the bolt seats of the planetary carrier. Preferably, the second surface too is designed to form an interlocking connection in a press fit with the bolt seat. Since the first and the second surfaces are both involved in the press connection, the load-bearing capacity of the press connection is increased still further.

### BRIEF DESCRIPTION OF THE DRAWINGS

An example embodiment described below is illustrated in the figures. In these, the same indexes denote the same, or functionally equivalent features. In detail, the figures show;

FIG. 1: A view of a planetary carrier, seen from above;

FIG. 2: A first sectioned view of the planetary carrier; and

FIG. 3: A second sectioned view of the planetary carrier.

### DETAILED DESCRIPTION OF THE PREFERRED EMBODIMENTS

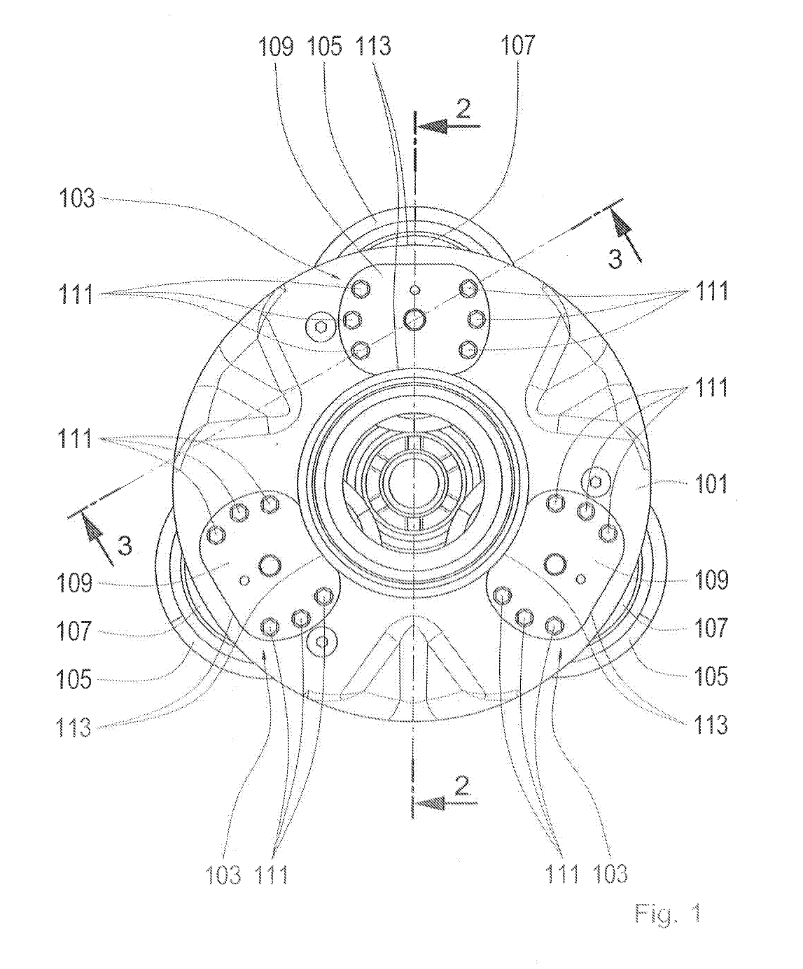

The perspective view shown in FIG. 1 is a view onto a planetary carrier 101 seen from a perspective in the axial direction. Into this planetary carrier 101 are inserted three planetary bolts 103. In each case a planetary gearwheel 105 is mounted to rotate on the planetary bolts 103. To fit the planetary gearwheels 105, conical roller bearings 107 are used.

The planetary bolts 103 each have a flange 109. This is connected to the planetary carrier 101 by means of six screw-bolts 111.

As can be seen from FIG. 1, the flange 109 is asymmetrical. The flange 109 has a basic shape with a partially circular cross-section. Deviations from circularity are produced by flattened or recessed sections 113. These make the flange 109 rotationally asymmetrical and thereby prevent the planetary bolt 103 from being able to twist relative to the planetary carrier 101.

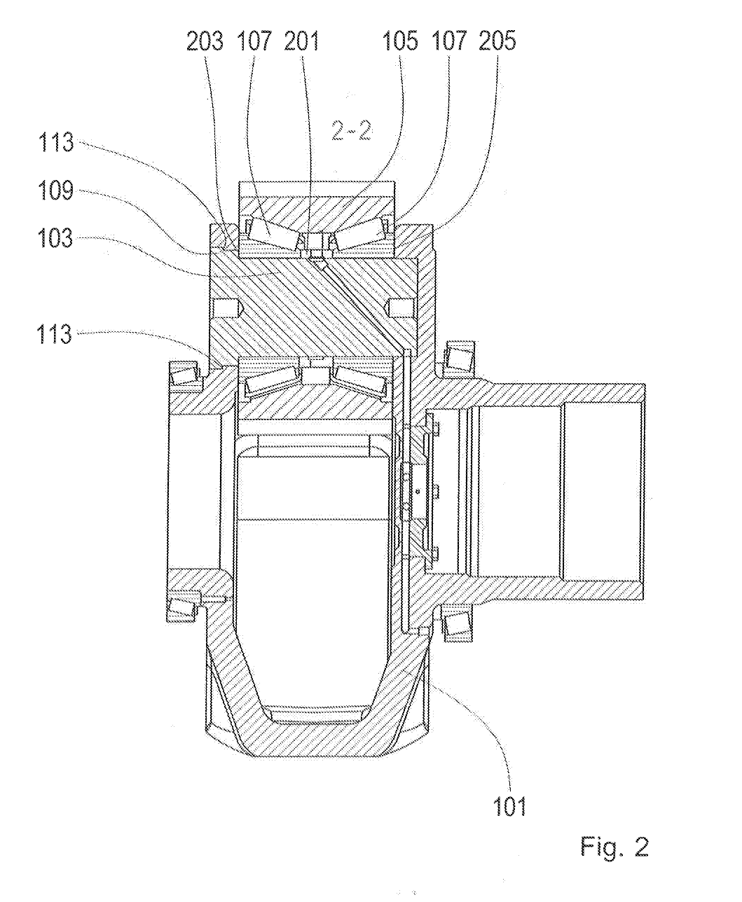

The cross-section 2-2 indicated in FIG. 1 is shown in FIG. 2. The cross-section 2-2 passes through the flattened and recessed sections 113. Accordingly, the screw-bolts 101 cannot be seen in FIG. 2. It is clear that the recessed areas 113 are in direct contact with the planetary carrier 101. This is important for the securing action against twisting described above.

The planetary bearings 107 are conical roller bearings. These are fitted in the O-arrangement. An intermediate ring 201 is arranged between the inner races of the planetary bearings 107 and keeps them a distance apart from one another. The inner races of the planetary bearings 107 and the intermediate ring 201 are arranged between the shoulder 203 and a radially directed annular surface 205 of the planetary carrier 101 that extends around the planetary bolts 103. Consequently, the shoulder 203 and the surface 205 fix the planetary bearings 107 and hence also the planetary gearwheels 105 in the axial direction.

Between the planetary carrier 101 and the planetary bolt 103 a press-fit connection is formed, which fixes the planetary bolt 103 relative to the planetary carrier 101, especially in the axial direction. Moreover, the planetary bolt 103 is fixed in the axial direction relative to the planetary carrier 101 by the screw-bolts 111. This is made clear by the sectional view 3-3 indicated in FIG. 1.

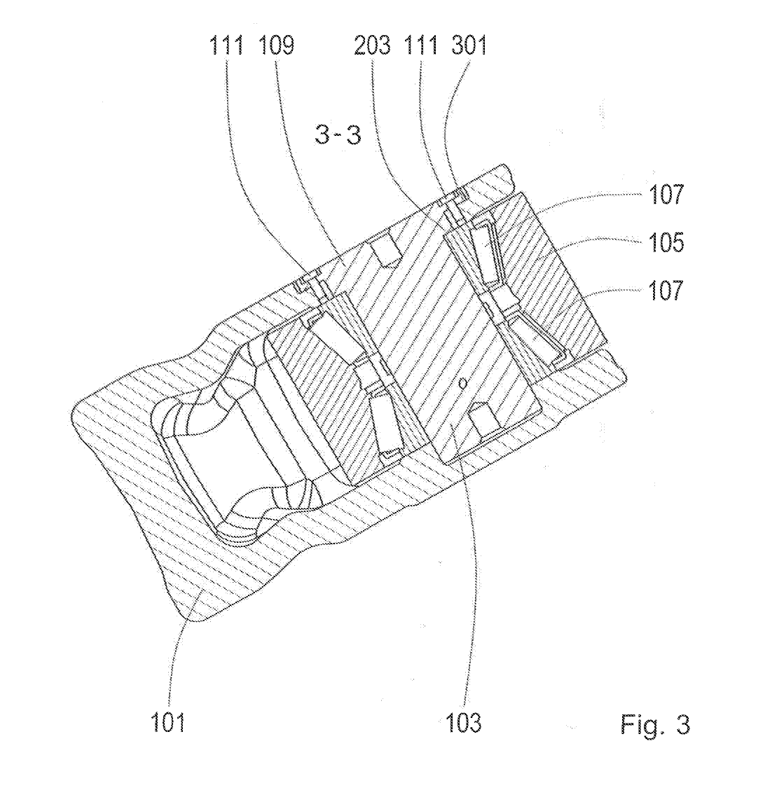

The sectional view 3-3 is shown in FIG. 3. Besides the shoulder 203 for fixing the planetary bearing 107 axially, the flange 109 of the planetary bolt 103 has a further shoulder 301. This comes in contact with a corresponding surface of the planetary carrier 101 and thus fixes the planetary bolt 103 in an axial direction facing toward the planetary bearing 107, i.e. the shoulder 301 blocks any displacement of the planetary bolt 103 in the axial direction toward the planetary bearing 107.

In an axial direction facing away from the planetary bearing 107, the planetary bolt 103 is fixed by the screw-bolts 111, i.e. the screw-bolts block any displacement of the planetary bolt 103 in the axial direction away from the planetary bearing 107.

Together with the shoulder 301, the screw-bolts 111 prevent any axial displacement of the planetary bolt 103 relative to the planetary carrier 101. The fixing of the planetary bolt 103 by the press-fit connection with the planetary carrier 101 on the one hand, and by the shoulder 301 and the screw-bolts 111 on the other hand, thus act in the same sense and reinforce one another. This improves the load-bearing capacity of the planetary bolt 103 in the axial direction.

### INDEXES

101 planetary carrier
103 Planetary bolt
105 Planetary gearwheel
107 Conical roller bearing
109 Flange
111 Screw-bolt
113 Recessed section
201 intermediate ring
203 Shoulder
205 Surface
301 Shoulder

1-4. (canceled)

5. A planetary bolt (103) comprising:
a flange (109),
at least one through-bore with two open ends, and
the flange (109) contains the two open ends.

6. The planetary bolt (103) according to claim 5, wherein the flange (109) is rotationally asymmetrically.

7. The planetary bolt (103) according to claim 5, wherein
the flange (109) has at least a first surface, a second surface and a third surface (301),
the first surface and the second surface are designed to participate in a frictional connection with a planetary carrier (101),
the third surface (301) connects the first and the second surfaces, and
one of the two open ends is located in the third surface.

8. A planetary carrier (101) in combination with a planetary bolt, the planetary bolt comprises:
a flange (109),
at least one through-bore with two open ends,
the flange (109) contains the two open ends,
the planetary carrier receives the planetary bolt (103), and the flange (109) is bolted onto the planetary carrier (101).
